(19) United States
(12) Patent Application Publication
(10) Pub. No.: US 2006/0045586 A1
(43) Pub. Date: Mar. 2, 2006

(54) Fusing roller and fusing apparatus having the same

(75) Inventors: Hwan-guem Kim, Seoul (KR); Joong-gi Kwon, Gunpo-si (KR); Durk-hyun Cho, Suwon-si (KR); Young-min Chae, Suwon-si (KR); Sang-yong Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/154,528

(22) Filed: Jun. 17, 2005

(30) Foreign Application Priority Data
Aug. 25, 2004 (KR) 10-2004-0067090

(51) Int. Cl. G03G 15/20

(52) U.S. Cl. 399/328; 399/330

(57) ABSTRACT

A fusing roller and a fusing apparatus having the fusing roller are provided. The fusing roller includes a roller unit and an induced heat generation unit that is installed on an outer circumferential surface of the roller unit. Eddy currents are generated in the roller unit in response to an alternating current input thereto. An insulation unit insulates the induced heat generation unit from the roller unit.

### CROSS REFERENCE TO RELATED APPLICATION

This application claims the benefit under 35 U.S.C. § 119(a) of Korean Patent Application No. 10-2004-0067090, filed on Aug. 25, 2004, in the Korean Intellectual Property Office, the entire disclosure of which is hereby incorporated by reference.

### BACKGROUND OF THE INVENTION

1. Field of the Invention

The present invention relates to a fusing apparatus. More particularly, the present invention relates to a fusing roller that makes a roller unit firmly contact an induced heat generation unit to generate induced heat that takes advantage of the concentration of magnetic fluxes, and thus maximizes the efficiency of the induced heat generation unit and a fusing apparatus having the fusing roller.

2. Description of the Related Art

Generally, electrophotographic image forming apparatuses, such as laser printers and digital copiers, print a unicolored or multicolored image by applying light to a photosensitive medium charged with predetermined potentials to form a latent electrostatic image on the photosensitive medium. A developer is enabled to develop the latent electrostatic image with a predetermined color of toner. The developed toner image is transferred to a sheet of paper. The transferred image is fused onto a sheet of paper.

Electrophotographic printing apparatuses are classified into either wet-type electrophotographic printing apparatuses or dry-type electrophotographic printing apparatuses according to the type of developing agent that they use. Wet-type electrophotographic printing apparatuses use a developing agent in which toner particles are diffused into a liquid carrier. Dry-type electrophotographic printing apparatuses use a homogenous developing agent, which is composed of toner particles, or a heterogeneous developing agent, which is a mixture of carrier particles and toner particles.

FIG. 1 is a longitudinal cross-sectional view schematically illustrating a conventional fusing apparatus 10 using a halogen lamp as a heat source. FIG. 2 is a longitudinal cross-sectional view of the conventional fusing apparatus of FIG. 1 taken along line I-I′ of FIG. 1. Referring to FIGS. 1 and 2, the fusing apparatus 10 includes two fusing rollers 11 and 12, which are formed of aluminum as cylinders. Both ends of each of the fusing rollers 11 and 12 are supported by bearings 14. The fusing rollers 11 and 12 are installed to contact each other along longitudinal directions thereof. A coat layer 13 is formed on the surface of each of the fusing rollers 11 and 12. The coat layer 13 forms a nip through which heat is transferred from each of the fusing rollers 11 and 12 to a toner image 21 on a recording medium 20. The nip also facilitates easily detaching each of the fusing rollers 11 and 12 from the toner image 21 fused onto the recording medium 20.

A heating portion 15 is installed at the center of each of the fusing rollers 11 and 12 and uses, as a heat source, a halogen lamp that emits heat when connected to an external power supply (not shown). The heating portion 15 is separated from the inner surface of each of the fusing rollers 11 and 12 with an empty space therebetween filled with air.

When a current supplied by the external power supply is applied to both ends of the heating portion 15, the heating portion 15 generates radiant energy. The radiant energy is transmitted to the inner surface of each of the fusing rollers 11 and 12 via air and is then converted into thermal energy passing through a light-heat conversion layer, which is formed of a black body. Then, the thermal energy is conducted to the nip, which is an interface between the fusing rollers 11 and 12, through the fusing rollers 11 and 12 and the coat layer 13. The thermal energy is then transmitted to the toner image 21 on the recording medium 20 so that the toner image 21 is fused onto the recording medium 20 by the thermal energy.

However, the conventional fusing apparatus using a halogen lamp as a heat source has several disadvantages.

First, since a halogen lamp has a low thermal efficiency, a considerable amount of time is required for warming the halogen lamp until the temperature of the halogen lamp reaches a desired fusing temperature. Therefore, a user has to wait to print documents until the halogen lamp is heated to the desired fusing temperature and the conventional fusing apparatus is ready.

Second, since the halogen lamp is separated from the inner surface of each of the fusing rollers 11 and 12 with the empty space therebetween filled with air, heat emitted from the halogen lamp heats each of the fusing rollers 11 and 12 through radiation and passes through the fusing rollers 11 and 12 through conduction. Therefore, the speed of transmitting heat from the halogen lamp to the fusing rollers 11 and 12 is relatively slow. Additionally, the heat emitted from the halogen lamp is also transmitted to the recording medium 20, thereby causing differences in temperatures between portions of the recording medium 20 where the toner image 20 is formed and other portions of the recording medium 20 where no toner image is formed. However, it takes the conventional fusing apparatus a while to compensate for the temperature differences, and thus, it is difficult to achieve an even distribution of temperatures over the recording medium 20.

Finally, to achieve a smooth transition from one printing operation to another printing operation, the conventional fusing apparatus consumes a considerable amount of power consecutively supplying a current to the heating portion and uniformly maintaining the temperature of the fusing rollers 11 and 12.

Accordingly, a need exists for a fusing apparatus having a fusing roller that effectively and efficiently transfers heat through the fusing rollers to the nip therebetween.

### SUMMARY OF THE INVENTION

Embodiments of the present invention-provides a fusing roller that enhances the efficiency of an induced heat generation unit by firmly contacting the induced heat generation unit with a roller unit so that the induced heat generation unit rotates together with the roller unit and increases the efficiency of fusing a toner image onto a recording medium by using both resistive heat generated due to the resistance of the induced heat generation unit and induced heat generated due to an eddy current. Embodiments of the present invention also provide a fusing apparatus having the fusing roller.

According to an aspect of the present invention, a fusing roller includes a roller unit. An induced heat generation unit is installed on an outer circumferential surface of the roller unit and generates eddy currents in the roller unit in response to an alternating current input thereto. An insulation unit insulates the induced heat generation unit from the roller unit.

The induced heat generation unit may be formed on the outer circumferential surface of the roller unit through etching.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a longitudinal cross-sectional view of a conventional fusing apparatus using a halogen lamp as a heat source;

FIG. 2 is a side elevational view in cross-section of the conventional fusing apparatus of FIG. 1 taken along line I-I′ of FIG. 1;

FIG. 3 is a front elevational view in cross-section view of a fusing apparatus according to an exemplary embodiment of the present invention;

FIG. 4 is an enlarged view of a portion of a fusing roller of FIG. 3;

FIGS. 5A and 5B are front elevational views in cross-section illustrating a method of forming an induced heat generation unit of FIG. 3 through etching;

FIG. 6 is a circuit diagram of a power supply unit of the fusing roller of FIG. 3;

FIG. 7 is a front elevational view in cross-section illustrating the generation of induced heat in the fusing roller of FIG. 3 with the use of an eddy current; and

FIG. 8 is a front elevational view in cross-section of a heat source of the fusing roller of FIG. 3.

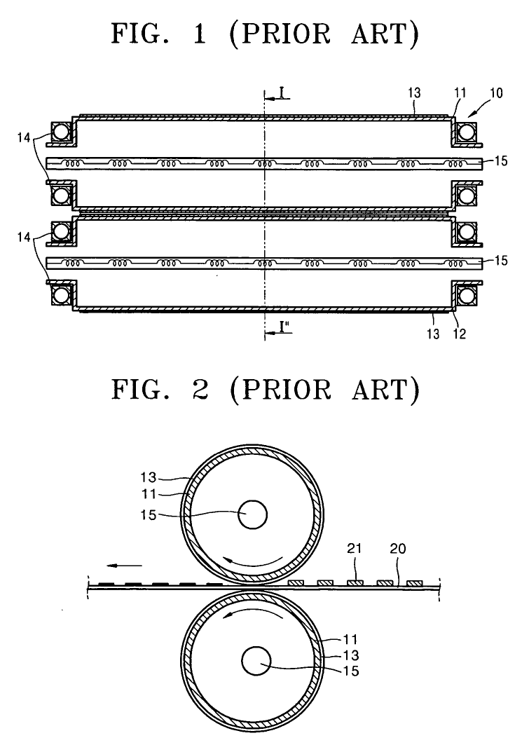

Throughout the drawings, like reference numerals will be understood to refer to like parts, components and structures.

### DETAILED DESCRIPTION OF EXEMPLARY EMBODIMENTS

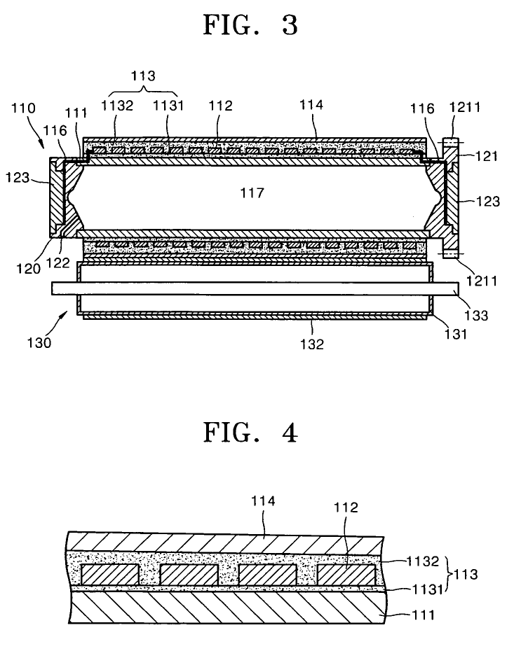

Referring to FIGS. 3 and 4, a fusing apparatus 100 includes a fusing roller 110, which generates heat that fuses a toner image (not shown) on a recording medium (not shown), and a press roller 130, which is installed to contact the fusing roller 110 along a longitudinal direction thereof and presses the recording medium down on the fusing roller 110. The recording medium passes through a nip between the fusing roller 110 and the press roller 130.

The press roller 130 is supported by an axial member 133 so that a body 131 of the press roller 130 rotates about the axial member 133. The body 131 of the press roller 130 is formed as a pipe. A coat layer 132 is formed on the outer circumferential surface of the body 131 to facilitate easily detaching the fusing roller 110 from the toner image after fusing the toner image onto the recording medium. Alternatively, the fusing roller 110 may be formed to apply both heat and pressure to the recording medium, in which case, the press roller 130 is unnecessary.

The fusing roller 110 has a roller unit 111, an induced heat generation unit 112, an insulation unit 113, and a power supply unit 140 (FIG. 6).

The roller unit 111 is formed of a resistive material as a pipe. The roller unit 111 is magnetized by a magnetic field and is a conductor that conducts current therethrough. Preferably, but not necessarily, the roller unit 111 is formed of iron alloy, copper alloy, aluminium alloy, nickel alloy, or chrome alloy.

The induced heat generation unit 112 is installed on the outer circumferential surface of the roller unit 111 and generates an alternating magnetic flux that varies depending on the intensity of current input from the power supply unit 140. Preferably, but not necessarily, the induced heat generation unit 112 is formed of a copper-based ribbon coil. The induced heat generation unit 112 is coated with the insulation unit 113 so that the induced heat generation unit 112 may be spaced from the outer circumferential surface of the roller unit 111.

The insulation unit 113 has a first insulator 1131, which covers the outer circumferential surface of the roller unit 111 and insulates the induced heat generation unit 112 from the roller unit 111, and a second insulator 1132, which covers the induced heat generation unit 112. Preferably, the insulation unit 113 is resistant to dielectric breakdown even when an alternating current is input to the induced heat generation unit 112. The first insulator 1311 substantially prevents the alternating current from flowing into the roller unit 111 by insulating the induced heat generation unit 112 from the roller unit 111.

Preferably, the insulation unit 113 has a high withstand voltage and a high dielectric breakdown resistance. If the insulation layer 113 endures a high power supply voltage supplied from outside the fusing roller 110, the insulation layer 113 has a high withstand voltage. If the insulation layer 113 generates a leakage current of less than 10 mA for one minute and does not dielectrically break down when a power supply voltage, which is not higher than the withstand voltage (6 Kvac or higher) of the insulation layer 113, is applied to the fusing roller 110, the insulation layer 113 has high dielectric breakdown resistance. The insulation layer 113 may be formed of mica, polyimide, ceramic, silicon, polyurethane, glass, or polytetrafluoruethylene (PTFE).

A coat layer 114 is formed of PTFE on the outer circumferential surface of the second insulator 1132 and facilitates easily detaching the roller unit 111 from the toner image fused onto the recording medium.

The induced heat generation unit 112 is preferably spirally disposed on the outer circumferential surface of the roller unit 111. The induced heat generation unit 112 may be formed by winding a resistive material with a predetermined thickness and a predetermined length around the roller unit 111 or by forming an induced coil layer of photoresist on the outer circumferential surface of the roller unit 111 and then etching the induced coil layer into a spiral. Accordingly, the induced heat generation unit 112 firmly contacts the roller unit 111 so that the induced heat generation unit 112 rotates together with the roller unit 111.

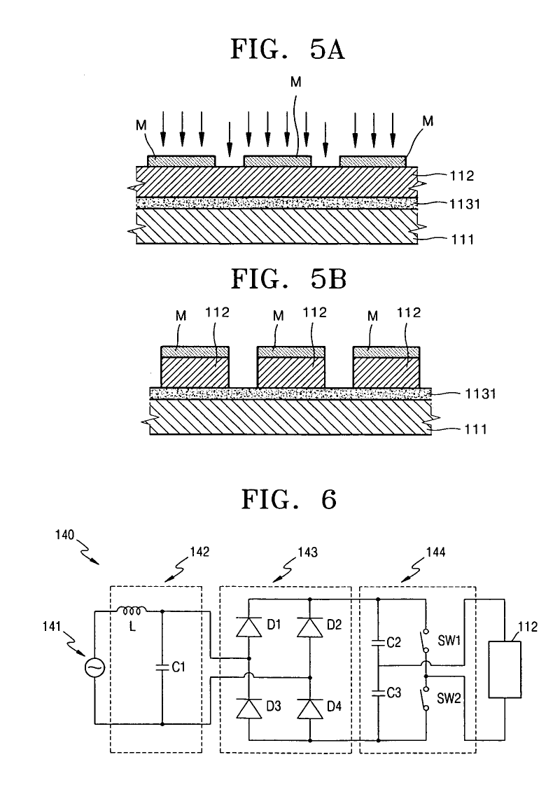

The method of forming the induced heat generation unit 112 through etching is well known to those skilled in the art and thus will be briefly described with reference to FIGS. 5A and 5B.

Referring to FIGS. 5A and 5B, an induced coil layer is formed on the first insulator 1131 to a predetermined thickness, and then a photomask film M is formed on the induced coil layer to define the pattern of the induced heat generation unit 112 on the induced coil layer.

Thereafter, light is applied to the induced coil layer such that only portions of the induced coil layer unmasked by the photomask film M are exposed. Thereafter, the exposed portions of the induced coil layer are etched by using chemicals. Thereafter, the photomask film M is removed, thereby obtaining the induced heat generation unit 112.

Both ends of the induced heat generation unit 112 are connected to a lead unit 116 so that the induced heat generation unit 112 may be electrically connected to the power supply unit 140 via the lead unit 116.

When an alternating current is input to the induced heat generation unit 112, an alternating magnetic flux is generated in the induced heat generation unit 112. The alternating magnetic flux generates an eddy current in the roller unit 111. Since the roller unit 111 has resistance, it generates resistive heat in response to the eddy current input thereto.

An end cap 120 and a driving force transferring end cap 121 are respectively formed at both ends of the roller unit 111. The driving force transferring end cap 121 is the same as the end cap 120 except that the driving force transferring end cap 121 includes a driving force transferring unit (not shown), such as a gear, which is connected to an electromotive apparatus (not shown) and rotates the fusing roller 110.

An air vent 122 is formed in the end cap 120. The air vent 122 allows air to come in and go out of an inner space 117 of the heating roller 111 so that the inner space 117 may be maintained at atmospheric pressure.

Therefore, even when the roller unit 111 is heated by heat transferred from the induced heat generation unit 112, the inner space 117 of the roller unit 111 may be maintained at atmospheric pressure because the air outside the inner space 117 keeps coming into the inner space 117 via the air vent 122. The air vent 122 may be formed at the driving force transferring end cap 121. Alternatively, the air vent 122 may be formed at both the end cap 120 and the driving force transferring end cap 121.

An electrode 123 is installed at each of the end caps 120 and the driving force transferring end caps 121. The electrodes 123 are electrically connected to the lead unit 116. A current supplied from an external power supply unit (not shown) is transmitted to the induced heat generation unit 112 via the power supply unit 140, the electrode 123, and the lead unit 116.

Referring to FIG. 6, the power supply unit 140 includes a power supply 141, a line filter 142, a rectifier 143, and a high frequency current generator 144.

The power supply 141 provides the line filter 142 with an alternating current having a predetermined magnitude and frequency.

The line filter 142 includes an inductor L and a capacitor C1 and removes high frequency components from the alternating current received from the power supply 141. In other words, the line filter 142 smoothes the alternating current received from the power supply 141.

The rectifier 143 rectifies the alternating current, from which the high frequency components have already been removed by the line filter 142, thereby generating a direct current. The rectifier 143 may be a bridge rectifier composed of four diodes D1, D2, D3, and D4 to rectify an alternating current into a direct current based on the polarization of the four diodes D1, D2, D3, and D4.

The high frequency current generator 144 receives the direct current from the rectifier 143 and generates an alternating current with a high frequency based on the received direct current. The high frequency current generator 144 includes two capacitors C2 and C3 and two switches SW1 and SW2 and converts a direct current, obtained as a result of rectifying an alternating current, into an alternating current with a high frequency by turning on or off one or both of the switches SW1 and SW2. A low frequency current generator may be used instead of the high frequency current generator 144. The power supply unit 140 may have a different structure from the one set forth herein.

The generation of heat in the fusing roller 110 is described in further detail below.

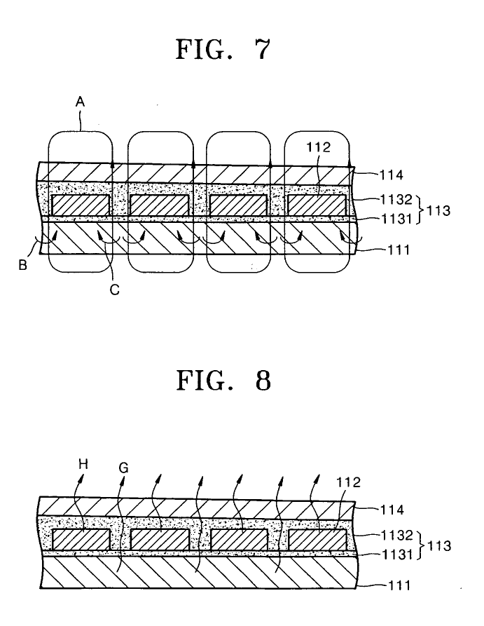

FIG. 7 is an elevational view in cross section illustrating the generation of induced heat in the fusing roller of FIG. 3 with the use of an eddy current. FIG. 8 is an elevational view in cross section of a heat source of the fusing roller of FIG. 3. Referring to FIGS. 3, 6, 7, and 8, when an alternating current is input from the power supply unit 140 to the induced heat generation unit 112, the induced heat generation unit 112 generates an alternating magnetic flux A marked by solid lines in FIG. 7. The alternating magnetic flux A is interlinked with the roller unit 111. Thus, the variation of the alternating magnetic flux A generates eddy currents B and C of opposite directions in the roller unit 111. Current flows in the induced heat generation unit 112 from a downward direction to an upward direction.

Since the roller unit 111 has resistance, heat (hereinafter referred to as induced Joule heat G) is induced in the roller unit 111 by the eddy currents B and C. The induced Joule heat G is transmitted to a toner image (not shown) via the coat layer 114 by the roller unit 11.

Since the induced heat generation unit 112 also has resistance, heat (hereinafter referred to as resistive Joule heat H) is generated in the induced heat generation unit 112 due to the alternating current input to the induced heat generation unit 112. The resistive Joule heat H is transmitted to the toner image via the second insulator 1132 and the coat layer 114.

Therefore, when the alternating current is input to the induced heat generation unit 112, the resistive Joule heat H is generated in the induced heat generation unit 112 in response to the alternating magnetic flux A input to the induced heat generation unit 112. The induced Joule heat G is induced in the roller unit 111 by the eddy currents B and C generated by the alternating magnetic flux A. The resistive Joule heat H and the induced Joule heat G fuse the toner image onto a recording medium (not shown).

As described above, the fusing roller according to the present invention has several advantages. First, since an induced heat generation unit is formed of a high dielectric material through etching so that it firmly contacts the outer circumferential surface of a roller unit, the magnetic fluxes are concentrated on the induced heat generation unit and enhance the efficiency of the induced heat generation unit.

Second, the time required for warming the fusing roller up until the fusing roller is heated to a target fusing temperature is reduced by using both resistive Joule heat, generated in the induced heat generation unit, and induced Joule heat, induced in the roller unit by eddy currents.

While exemplary embodiments have been chosen to illustrate the invention, it will be understood by those skilled in the art that various changes and modifications may be made therein without departing from the scope of the invention as defined in the appended claims.

What is claimed is:

1. A fusing roller, comprising:
a roller unit;
an induced heat generation unit disposed on an outer circumferential surface of the roller unit and generates eddy currents in the roller unit in response to an alternating current input thereto; and
an insulation unit to insulate the induced heat generation unit from the roller unit.

2. The fusing roller of claim 1, wherein
the induced heat generation unit is formed on the outer circumferential surface of the roller unit through etching.

3. The fusing roller of claim 1, wherein
the induced heat generation unit is wound around the roller unit.

4. The fusing roller of claim 3, wherein
the induced heat generation unit is spirally wound on the outer circumferential surface of the roller unit.

5. The fusing roller of claim 2, wherein
the insulation unit has a first insulator disposed between the induced heat generation unit and the roller unit to insulate the induced heat generation unit from the roller unit and a second insulator that covers the induced heat generation unit.

6. The fusing roller of claim 1, wherein
the roller unit is heated by resistive Joule heat generated in the induced heat generation unit due to the resistance of the induced heat generation unit and by induced Joule heat induced in the roller unit due to the eddy currents.

7. The fusing roller of claim 1, wherein
the induced heat generation unit is a coil.

8. The fusing roller of claim 1, wherein
a power supply unit supplies an alternating current having a high frequency to the induced heat generation unit.

9. The fusing roller of claim 1, wherein
the roller unit has an internal cavity.

10. The fusing roller of claim 9, wherein
a vent in the roller unit connected to the cavity facilitates maintaining the internal cavity at atmospheric pressure.

11. A fusing apparatus, comprising:
a fusing roller to generate heat to fuse a toner image onto a recording medium;
a press roller facing the fusing roller to press the recording medium down on the fusing roller, the fusing roller including
a roller unit;
an induced heat generation unit that is installed on an outer circumferential surface of the roller unit and generates eddy currents in the roller unit in response to an alternating current input thereto; and
an insulation unit to insulate the induced heat generation unit from the roller unit.

12. The fusing apparatus of claim 11, wherein
the induced heat generation unit is formed on the outer circumferential surface of the roller unit through etching.

13. The fusing apparatus of claim 11, wherein
the induced heat generation unit is wound around the roller unit.

14. The fusing apparatus of claim 13, wherein
the induced heat generation unit is spirally wound around the roller unit.

15. The fusing apparatus of claim 12, wherein
the insulation unit has a first insulator disposed between the induced heat generation unit and the roller unit to insulate the induced heat generation unit from the roller unit.

16. The fusing apparatus of claim 15, wherein
the insulation unit has a second insulator that covers the induced heat generation unit.

17. The fusing apparatus of claim 11, wherein
the roller unit is heated by resistive Joule heat generated in the induced heat generation unit due to the resistance of the induced heat generation unit and induced Joule heat induced in the roller unit due to the eddy currents.

18. The fusing apparatus of claim 11, wherein
the induced heat generation unit is a coil.

19. The fusing apparatus of claim 11, wherein
a power supply unit supplies an alternating current having a high frequency to the induced heat generation unit.

20. The fusing apparatus of claim 11, wherein
a vent in the roller unit supplies air to a cavity in the roller unit to facilitate maintaining the cavity at substantially atmospheric pressure.
